(19) United States
(12) Patent Application Publication
(10) Pub. No.: US 2026/0338211 A1
(43) Pub. Date: Oct. 29, 2026

(54) MOLDABLE LIGHTWEIGHT SURFACES EMPLOYING CONSTRAINED LAYER INFLATABLE TILES

(71) Applicant: Toyota Motor Engineering & Manufacturing North America, Inc., Plano, TX (US)

(72) Inventors: Koray Benli, Ann Arbor, MI (US); Yuyang Song, Ann Arbor, MI (US); Shinnosuke Shimokawa, Ann Arbor, MI (US); Umesh Gandhi, Farmington Hills, MI (US); Yun Ju Kim, Ann Arbor, MI (US); Jonathan Luntz, Ann Arbor, MI (US); Diann Brei, Milford, MI (US); Parvin Virdee, Ann Arbor, MI (US); Marianne Lee, Ann Arbor, MI (US); Ahmed Wasif, Warren, MI (US); Tiantian Li, Ann Arbor, MI (US)

(73) Assignees: Toyota Motor Engineering & Manufacturing North America, Inc., Plano, TX (US); Toyota Jidosha Kabushiki Kaisha, Aichi-ken (JP); The Regents of the University of Michigan, Ann Arbor, MI (US)

(21) Appl. No.: 19/190,318

(22) Filed: Apr. 25, 2025

(51) Int. Cl. F16B 1/00

(52) U.S. Cl. CPC F16B 1/00

(57) ABSTRACT

Methods and systems may provide for a moldable surface including a bladder, a first tile array positioned within the bladder, and a second tile array positioned within the bladder. The first tile array and the second tile array may be deformable and inflatable.

### TECHNICAL FIELD

Embodiments generally relate to moldable surfaces. More particularly, embodiments relate to moldable lightweight surfaces employing constrained layer inflatable tiles.

### BACKGROUND

Recent developments in moldable surfaces may provide the ability to repeatedly conform the surfaces to different shapes, hold the shapes rigidly and reset to the original form of the surfaces. Conventional moldable surfaces, however, may be too bulky and/or heavy for many applications.

### BRIEF SUMMARY

In one embodiment, a moldable surface comprises a bladder, a first tile array positioned within the bladder, and a second tile array positioned within the bladder, wherein the first tile array and the second tile array are deformable and inflatable.

In another embodiment, an inflatable tile comprises a plurality of scaffold layers, wherein the plurality of scaffold layers are coupled to one another at a first set of anchor areas, a first skin layer coupled to a first side of the plurality of scaffold layers at a second set of anchor areas, and a second skin layer coupled to a second side of the plurality of scaffold array layers at a third set of anchor areas, wherein the first set of anchor areas are misaligned with the second set of anchor areas and the third set of anchor areas, and wherein the second set of anchor areas are aligned with the third set of anchor areas.

In yet another embodiment, a method of operating a moldable surface comprises inflating one or more tile arrays of the moldable surface, wherein the moldable surface is associated with one or more objects, and wherein the one or more tile arrays are positioned within a bladder, and vacuuming air out of the bladder, wherein vacuuming the air out of the bladder causes the moldable surface to hold a form factor of the one or more objects.

In yet another embodiment, a method of fabricating a moldable surface comprises constructing a bladder, positioning a first tile array within the bladder, and positioning a second tile array within the bladder, wherein tiles in the second tile array are offset from tiles in the first tile array, and wherein the first tile array and the second tile array are deformable and inflatable.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example of a usage scenario in which a mobile surface is draped over one or more objects according to an embodiment;

FIG. 2A is a perspective view of an example of a bladder and multiple tile arrays according to an embodiment;

FIG. 2B is a side view of an example of multiple tile arrays offset within a bladder according to an embodiment;

FIG. 3 is a plan view of an example of a moldable surface having a tile array inflation nozzle and a bladder vacuum nozzle according to an embodiment;

FIG. 4A is an exploded perspective view of an example of an inflatable tile according to an embodiment;

FIG. 4B is a perspective sectional view of an example of a tile in a deflated state and an inflated state according to an embodiment;

FIG. 4C is an illustration of an example of a tile in a deflated state according to an embodiment;

FIG. 4D is a side sectional view of an example of a tile in a deflated state and an inflated state according to an embodiment;

FIG. 4E is an illustration of an example of a tile in an inflated state according to an embodiment;

FIG. 5 is a perspective view of an example of a moldable surface according to an embodiment;

FIG. 6 is an exploded plan view of an example of a moldable surface having masks to define anchor areas according to an embodiment;

FIG. 7 is an exploded plan view of an example of a moldable surface having water-based ink to define inflatable regions around anchor areas according to an embodiment;

FIG. 8 is a plan view of an example of anchor area layouts according to embodiments;

FIG. 9 is an illustration of an example of a usage scenario in which a moldable surface is placed within one or more objects according to an embodiment;

FIG. 10 is a flowchart of an example of a method of operating a moldable surface according to an embodiment;

FIGS. 11A and 11B are flowcharts of examples of methods of fabricating a moldable surface according to an embodiment; and

FIG. 12 is a flowchart of an example of a method of fabricating a moldable surface using screen-printing technology according to an embodiment; and

FIG. 13 is a block diagram of an example of a moldable surface control system according to an embodiment.

### DETAILED DESCRIPTION

The ability of a moldable surface to repeatedly conform to different shapes, hold the shapes rigidly and reset to the original form of the surface has broad application in areas such as medical (e.g., reusable orthopedic casts, emergency patient restraining systems, wheelchair positioning devices), automotive (e.g., moldable cargo blanket, passenger safety blanket), entertainment (e.g., haptic feedback to enhance multimedia experience or immersive gaming), consumer goods (e.g., adaptable furniture, garments, shoes) industries, and so forth.

For these types of applications, adaptive moldable surfaces provide at least three advantageous sub-capabilities: drapability, shapability, and rigidizability. Drapability involves a surface passively arranging itself over the shape of a target object under the weight of the surface in a fabric-like manner. Shapability involves a surface being manually conformed to the curvature and shape of a desired configuration. Rigidizability involves a surface changing the stiffness of the surface on demand and holding the shape of the surface securely against external forces after being shaped.

Traditional materials, such as gallium-silicone composites and polyactic acid (PLA) polymers with heating elements, and smart materials, such as nickel-titanium shape memory alloys (SMAs) and polyurethane-based shape memory polymers, may offer on-demand stiffness control with temperature changes. These materials may be used in active finger braces, custom musculoskeletal supports, self-fitting space wearables, and morphing airfoils, but require operating temperatures (e.g., 20-100°C for polymers and 20-120°C for alloys) that add complexity and limit design flexibility for safe, user-friendly products.

An alternative approach for user-facing applications may involve pneumatically activated composites, where an airtight bladder contains arrays of solid granular, fibrous, layered, or tiled material. When air is vacuumed from the bladder, friction between the encapsulated solid components increases, enabling a transition from soft to rigid states. In general, these systems either lack compactness in both soft and rigid states due to the solid components within the systems, or the overall weight becomes problematic when the system is scaled up (e.g., 10 x 10 centimeters (cm) vs 1 x 1 meter (m) surfaces).

To address these problems, the technology described herein includes an entirely fabric-based moldable surface system that can transition between soft and rigid states, while being lightweight and compactly stowable. This moldable surface comprises an external vacuum bladder and multiple tile array layers positioned within the bladder, where each array is made of individual multilayered fabric-based tiles that can be inflated or deflated to affect the overall system behavior (e.g., drapability, shapability, rigidizability). The inflatable tiles are made of thin, airtight layers, where intentionally selected pairs of layers are constrained to one another in specific ways.

For example, a set of anchor points are established between scaffold layers and a different set of anchor points are established between scaffold and tile skin layers. Each individual tile has a perimeter sealing between the first and second tile skins. The vacuum bladder itself has a perimeter seal to ensure airtightness. Based on how the multiplicity of these layers are constrained, different kinds of functionalities can be generated (e.g., making an initially soft tile stiffer via encapsulating high-pressure air inside), which then are combined to create higher level functionalities (e.g., an array rigid of rigid tiles can be vacuumed to be compressed against one another, generating shape retention capability).

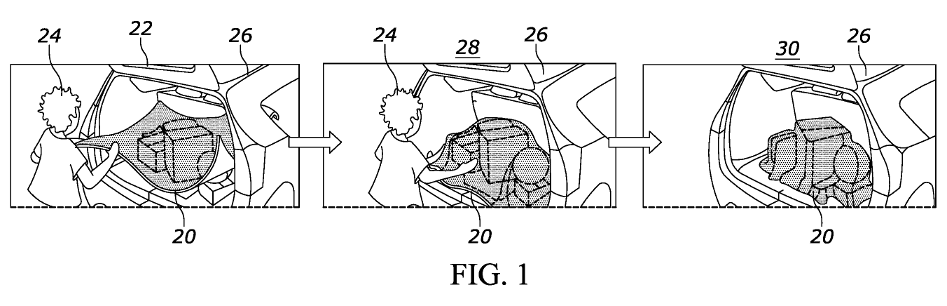

Turning now to FIG. 1, a usage scenario is shown in which a moldable surface 20 is used as a cargo blanket (e.g., to cover and hold objects in place during transport). In a first stage 22, the moldable surface 20 is in a draping state in which a user 24 is able to drape the moldable surface 20 over one or more objects in the trunk of a vehicle 26. In a second stage 28, manual external forces from the user 24 (e.g., hand shaping) enable the conformation of the moldable surface 20 into the form factor (e.g., shape profile) of the objects in the trunk. As will be discussed in greater detail, tile arrays (e.g., including multiple inflatable tiles) of the moldable surface 20 can be simultaneously or sequentially inflated during the second stage 28 to facilitate the shaping process. In one example, the tiles are positioned within an airtight bladder. In such a case, air may be vacuumed out of the bladder either during the second stage 28 or during a third stage 30 in which the moldable surface 20 is in a rigidizing state. In the rigidizing state, the moldable surface 20 becomes stiff while the maximum vacuum pressure is held inside the bladder.

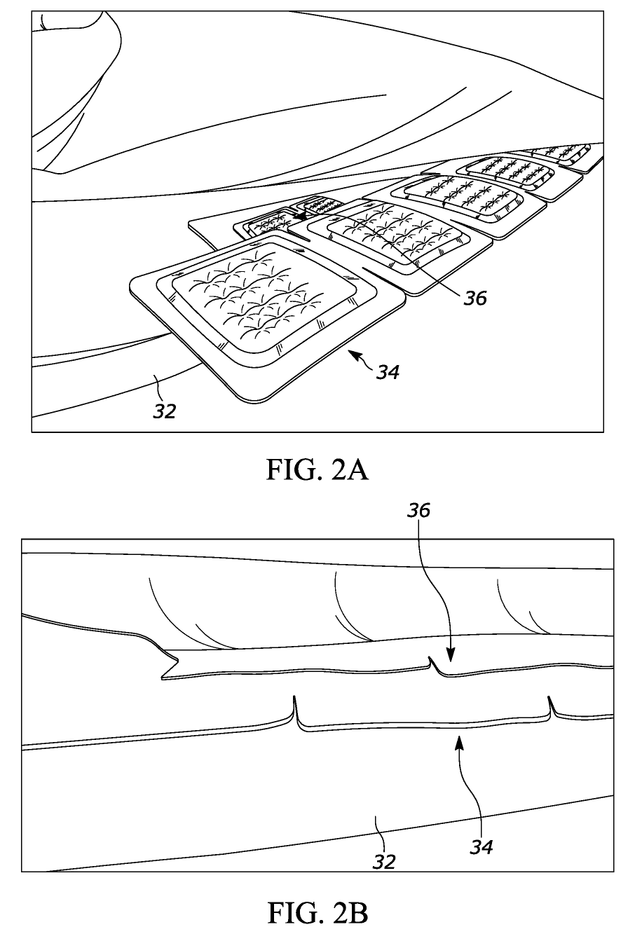

FIG. 2A shows a bladder 32 of a moldable surface, wherein the bladder 32 includes a first tile array 34 and a second tile array 36. In addition to being inflatable, the tiles of the tile arrays 34, 36 are soft and conformable to facilitate shaping of the moldable surface around or within various objects. In the illustrated example, the tile arrays 34, 36 have a linear (e.g., one-dimensional/1D configuration), although planar (e.g., two-dimensional/2D) configurations may also be used.

FIG. 2B shows the bladder 32 with the tile arrays 34, 36 positioned in an offset arrangement (e.g., half tile offset). The offset arrangement increases the shape retention capability of the moldable surface. For example, shaping can be conducted at the interface (e.g., hinge joint) between two tiles of one array due to an overlapping tile of an adjacent array, in the illustrated example.

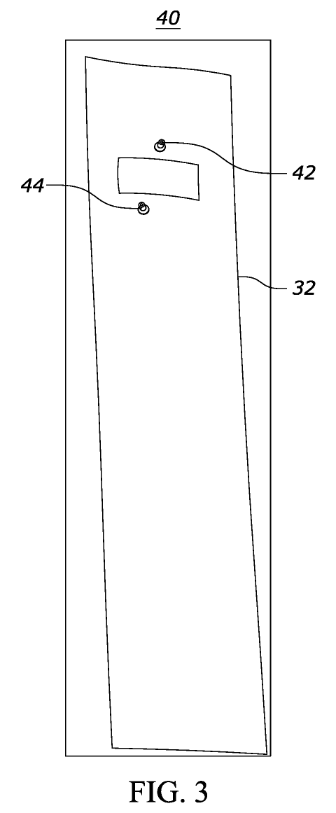

FIG. 3 shows a moldable surface 40 having a tile array nozzle 42 that can be used to inflate and deflate tile arrays within the bladder 32. Additionally, a bladder nozzle 44 can be used to inflate and deflate the bladder 32.

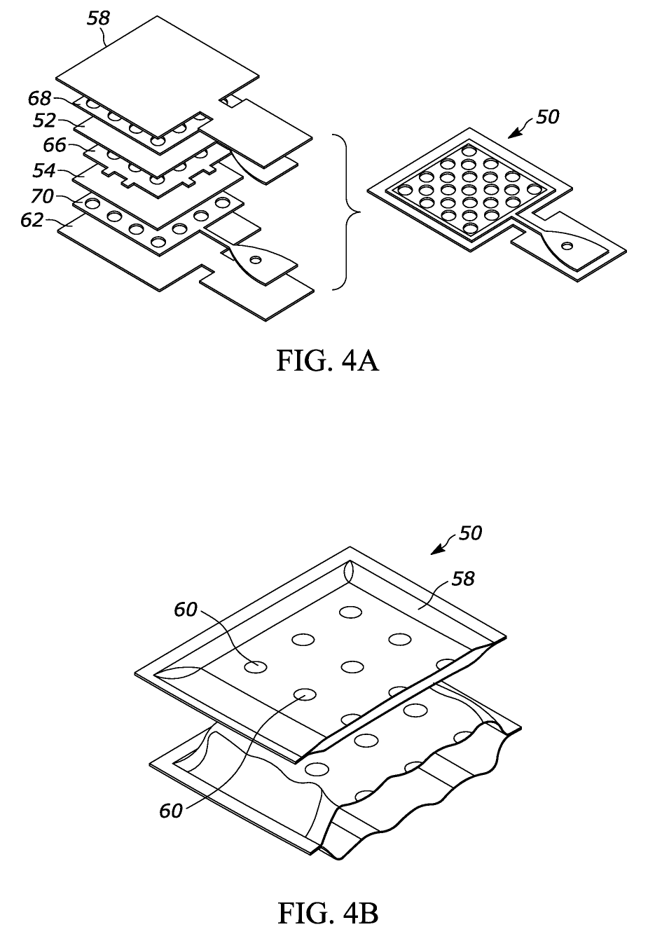

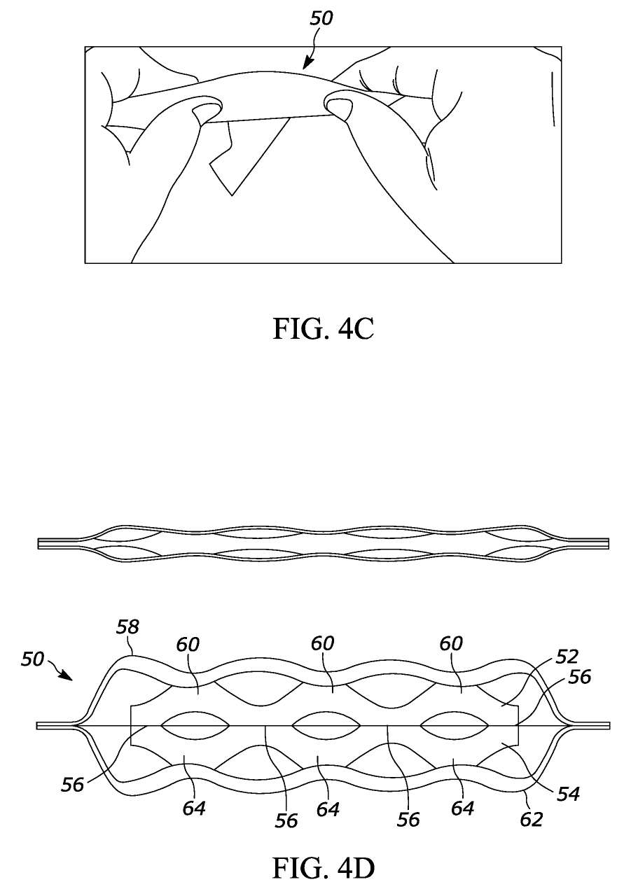

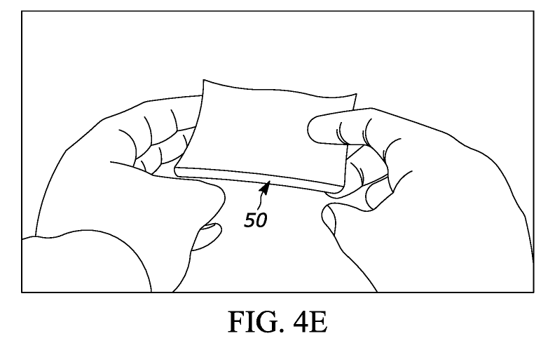

Turning now to FIGS. 4A-4E, the construction of an individual inflatable tile 50 is shown. As best shown in FIGS. 4A and 4D, the inflatable tile 50 includes a plurality of scaffold layers 52, 54, wherein the scaffold layers 52 are coupled to one another at a first set of anchor areas 56. The inflatable tile 50 also includes a first skin layer 58 coupled to a first side of the plurality of scaffold layers 52, 54 at a second set of anchor areas 60. Additionally, a second skin layer 62 is coupled to a second side of the plurality of scaffold layers 52, 54 at a third set of anchor areas 64. In the illustrated example, the first set of anchor areas 56 are intentionally misaligned with the second set of anchor areas 60 and the third set of anchor areas 64. Moreover, the second set of anchor areas 60 are aligned with the third set of anchor areas 64. This distributed misalignment/alignment configuration results in the inflatable tile 50 expanding into an egg carton-like shape when air is applied to the interior of the inflatable tile 50. Indeed, the illustrated fabric-based solution enables the tile 50 to be inflated to higher pressure levels without bursting, while ensuring that the tile 50 remains low-profile and relatively flat upon inflation (e.g., as opposed to forming a spherical shape). This enables the adjustment of tile stiffness as a function of the inflation pressure applied.

Masks 66, 68, 70 may be used to define the first, second and third sets of anchor areas 56, 60, 64. More particularly, an inner mask 66 can be positioned between the plurality of scaffold layers 52, 54, wherein the inner mask 66 defines the first set of anchor areas 56. Additionally, a first outer mask 68 is positioned between the first skin layer 58 and the first side of the plurality of scaffold layers 52, 54, wherein the first outer mask 68 defines the second set of anchor areas 60. Similarly, a second outer mask 70 is positioned between the second skin layer 62 and the second side of the plurality of scaffold layers 52, 54, wherein the second outer mask defines the third set of anchor areas 64. In an embodiment, the masks 66, 68, 70 are constructed from parchment paper and the scaffold layers 52, 54 are constructed from double-sided thermoplastic polyurethane (TPU) coated fabric (e.g., nylon, polyester, cotton, etc., coated with TPU on two sides of the fabric). Additionally, the skin layers 58, 62 may be constructed from single-sided TPU coated fabric (e.g., nylon, polyester, cotton, etc., coated with TPU only on one side of the fabric). TPU coating provides two key capabilities: 1) making the fabric layer airtight, and 2) TPU coating can be used as an adhesive when heated beyond its associated melting temperature. The entire moldable surface can also be made of layers of other types of thermoplastic or thermoset materials (e.g., vinyl coated fabric, rubber coated fabric). Additionally, other types of flexible but inextensible thin material layers can be used, and these layers can be fused to one another via various heat-sealing techniques (e.g., heat-pressing, ultrasonic welding) or via various chemical bonding techniques (e.g., using adhesives such as vinyl cement if the fabric layers have vinyl coating). As will be discussed in greater detail, the masks 66, 68, 70 may be replaced with water-based ink (e.g., via a screen-printing process).

As best shown in FIG. 4C, the tile 50 is lightweight, thin and easily deformable when deflated. As best shown in FIG. 4E, the tile 50 is lightweight, has a low profile and is stiffer when inflated. Thus, stiffness can be varied as a function of pressure applied.

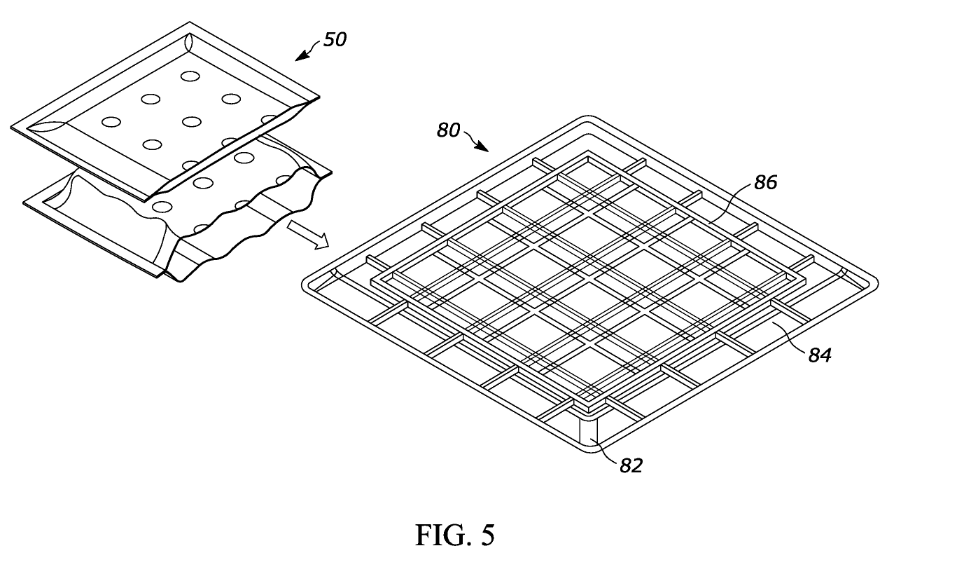

FIG. 5 shows a moldable surface 80 having a bladder 82, a first tile array 84 (e.g., 5x5 configuration) positioned within the bladder 82, and a second tile array 86 (e.g., 4x4 configuration) positioned within the bladder 82. In the illustrated example, the tile arrays 84, 86 include multiple instances of the inflatable tile 50. Accordingly, the moldable surface 80 is lightweight, compactly stowable, and able to provide variable stiffness on demand. The moldable surface 80 also has improved drapability performance because the entire system is made of fabric (e.g., as opposed to including solid components). In addition, the moldable surface 80 has improved shapability performance because each individual fabric-based tile 50 can deform to a degree to adapt to the target shape. Moreover, fabrication of the moldable surface 80 is easier and more scalable (e.g., screen printing, applicable for roll-to-roll production). Additionally, the moldable surface 80 contains no bulky or solid components (e.g., solid tiles or granules), which enables the development of fabric-based soft applications that are safer from a user interaction perspective. The illustrated solution also reduces the number of different materials used in the moldable surface 80, increasing the chances for enabling recyclability as a part of the product life-cycle.

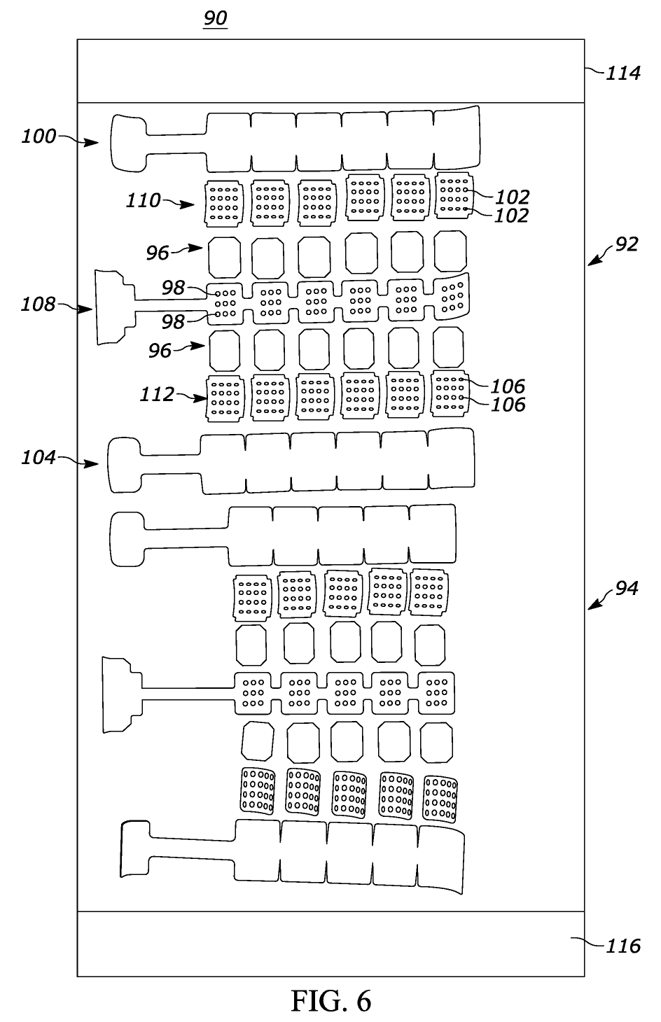

FIG. 6 shows an exploded plan view of a moldable surface 90 having a first tile array 92 and a second tile array 94. The first tile array 92 includes a plurality of scaffold layers 96 (e.g., double-sided TPU coated fabric), wherein the plurality of scaffold layers 96 are coupled to one another at a first set of anchor areas 98. A first skin layer 100 (e.g., tile frame including single-sided TPU coated fabric) is coupled to a first side of the plurality of scaffold layers 96 at a second set of anchor areas 102. Similarly, a second skin layer 104 (e.g., tile frame including single-sided TPU coated fabric) is coupled to a second side of the plurality of scaffold layers 96 at a third set of anchor areas 106. The first set of anchor areas 98 are misaligned (e.g., different anchor patterns) with the second set of anchor areas 102 and the third set of anchor areas 106. Additionally, the second set of anchor areas 102 are aligned (e.g., same anchor pattern) with the third set of anchor areas 106.

In the illustrated example, an inner mask 108 is positioned between the plurality of scaffold layers 96, wherein the inner mask 108 defines the first set of anchor areas 98. In addition, a first outer mask 110 is positioned between the first skin layer 100 and the first side of the plurality of scaffold layers 96, wherein the first outer mask 110 defines the second set of anchor areas 102. A second outer mask 112 is also positioned between the second skin layer 104 and the plurality of scaffold layers 96, wherein the second outer mask 112 defines the third set of anchor areas 106. In an embodiment, the second tile array 94 has a similar construction to the first tile array 92. In one example, the first tile array 92 and the second tile array 94 are positioned within a bladder constructed from a first bladder layer 114 (e.g., single-sided TPU coated fabric) and a second bladder layer 116 (e.g., single-sided TPU coated fabric). Thus, the first and second bladder layers 114, 116 may be sealed to one another at the edges to create an airtight compartment that contains the first and second tile arrays 92, 94.

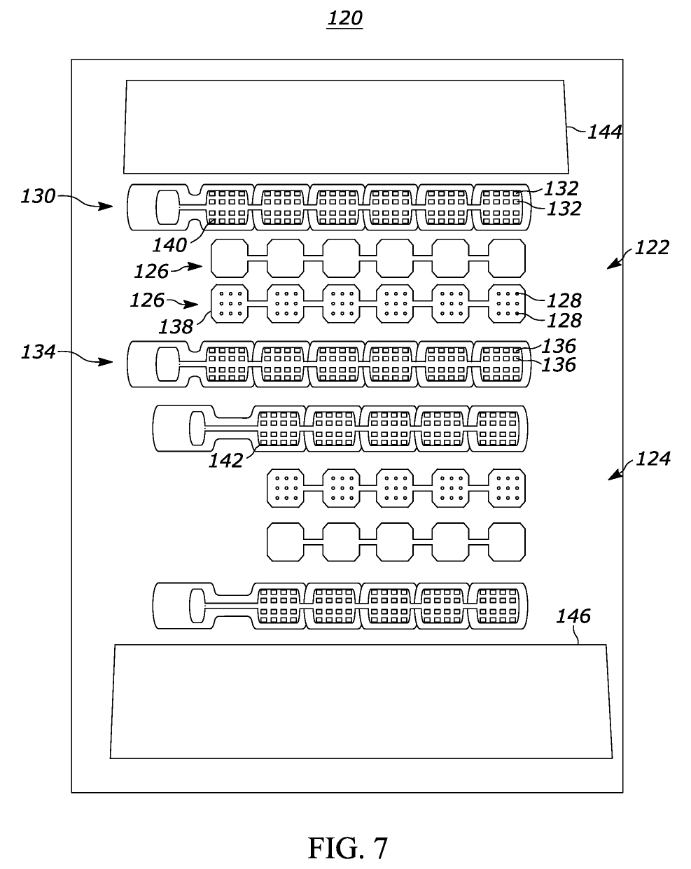

FIG. 7 shows another exploded plan view of a moldable surface 120 having a first tile array 122 and a second tile array 124. The first tile array 122 includes a plurality of scaffold layers 126 (e.g., double-sided TPU coated fabric), wherein the plurality of scaffold layers 126 are coupled to one another at a first set of anchor areas 128. A first skin layer 130 (e.g., tile frame including single-sided TPU coated fabric) is coupled to a first side of the plurality of scaffold layers 126 at a second set of anchor areas 132. Similarly, a second skin layer 134 (e.g., tile frame including single-sided TPU coated fabric) is coupled to a second side of the plurality of scaffold layers 126 at a third set of anchor areas 136. The first set of anchor areas 128 are misaligned (e.g., different anchor patterns) with the second set of anchor areas 132 and the third set of anchor areas 136. Additionally, the second set of anchor areas 132 are aligned (e.g., same anchor pattern) with the third set of anchor areas 136.

In the illustrated example, inner water-based ink 138 (e.g., from a screen-printing process) is positioned between the plurality of scaffold layers 126, acting as an embedded and significantly thinner masking layer, wherein the lack of inner water-based ink 138 defines the first set of anchor areas 128. More particularly, the area covered by the water-based ink 138 on the plurality of scaffold layers 126 (e.g., TPU coated fabric layers) becomes non-sealable when heated up and compressed against another TPU coated fabric layer. Therefore, whenever the tiles are inflated after a heat-sealing process, the areas covered by the water-based ink 138 separate from one another and define inflatable regions around the first set of anchor areas 128.

In addition, first outer water-based ink 140 is positioned between the first skin layer 130 and the first side of the plurality of scaffold layers 126, wherein the first outer water-based ink 140 defines inflatable regions around the second set of anchor areas 132. A second outer water-based ink 142 is also positioned between the second skin layer 134 and the plurality of scaffold layers 126, wherein the second outer water-based ink 142 defines inflatable regions around the third set of anchor areas 136. In an embodiment, the second tile array 124 has a similar construction to the first tile array 122. In one example, the first tile array 122 and the second tile array 124 are positioned within a bladder constructed from a first bladder layer 144 (e.g., single-sided TPU coated fabric) and a second bladder layer 146 (e.g., single-sided TPU coated fabric). Thus, the first and second bladder layers 144, 146 may be sealed to one another at the edges to create an airtight compartment that contains the first and second tile arrays 122, 124.

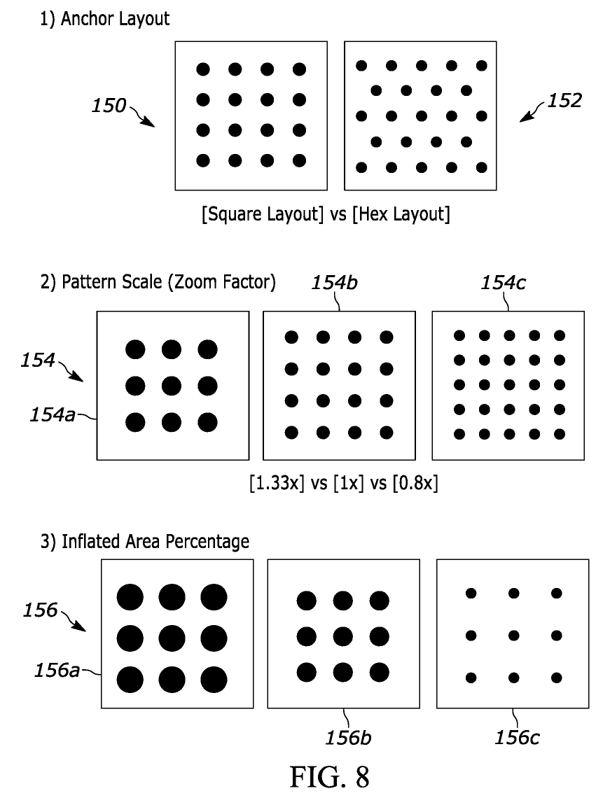

FIG. 8 shows layouts for anchor areas. For example, a first anchor layout 150 has a square geometry, whereas a second anchor layout 152 has a hexagonal (hex) geometry. Thus, the first anchor layout 150 might be used for the first set of anchor areas and the second anchor layout 152 might be used for the second and third sets of anchor areas (e.g., or vice versa). A set of zoomed anchor layouts 154 (154a-154c) demonstrate that, for example, the square geometry can be scaled to different sizes (e.g., 1.33x, 1x, 0.8x). Additionally, a set of inflated area layouts 156 (156a-156c) demonstrate that, for example, the area percentage of the square geometry can also be modified. In an embodiment, a relatively large area percentage of the anchors provides enhanced results through a greater bendable surface area in the moldable surface.

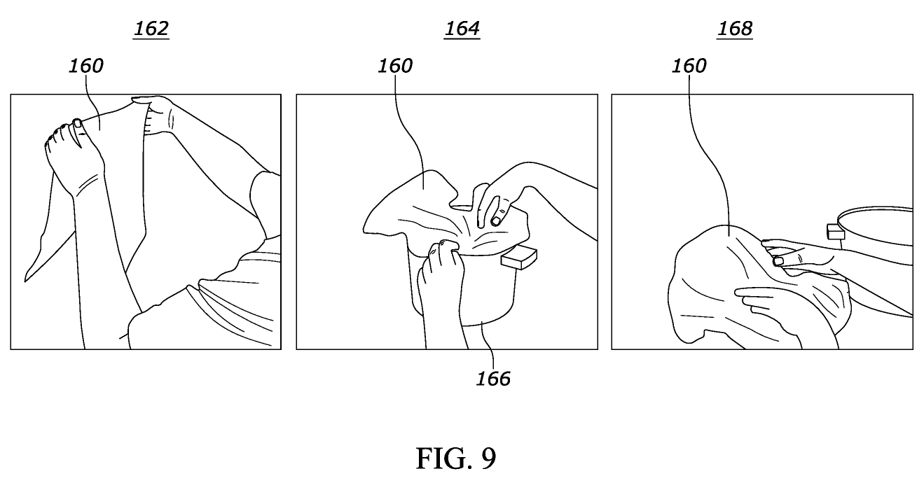

Turning now to FIG. 9, a usage scenario is shown in which a moldable surface 160 begins in a draping state 162. In a shaping state 164, the moldable surface 160 is placed within an object 166 (e.g., pot). In a rigidizing state 168, the moldable surface 160 remains rigidly molded into the form factor of the object 166 even after being removed from the object 166.

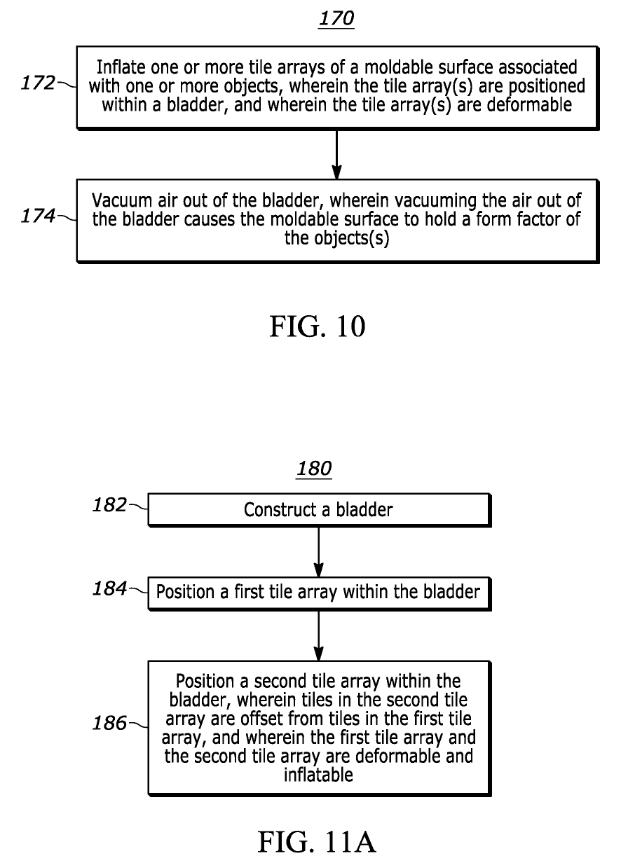

FIG. 10 shows a method 170 of operating a moldable surface such as, for example, the moldable surface 20 (FIG. 1), the moldable surface 40 (FIG. 3), the moldable surface 80 (FIG. 5), the moldable surface 90 (FIG. 6), the moldable surface 120 (FIG. 7) and/or the moldable surface 160 (FIG. 9), already discussed. The method 170 may be implemented in logic instructions (e.g., software), configurable logic, fixed-functionality hardware logic, etc., or any combination thereof. Illustrated processing block 172 provides for inflating one or more tile arrays of a moldable surface associated with one or more objects, wherein the tile array(s) are positioned within a bladder. In the illustrated example, the tile array(s) are deformable. The moldable surface may be draped over the object(s) (e.g., as a cargo blanket), placed within the object(s), wrapped around the object(s), and so forth. Block 174 vacuums air out of the bladder, wherein vacuuming the air out of the bladder causes the moldable surface to hold the form factor of the object(s). In one example, the air is vacuumed out of the bladder while the moldable surface is being shaped (e.g., by a user) to the form factor of the object(s). In another example, the air is vacuumed out of the bladder after the moldable surface has been shaped (e.g., by a user) to the form factor of the object(s).

The moldable surface may alternatively be operated in different sequences. For example, one approach would be to inflate a subset of the tiles (e.g., the tiles located around the perimeter), drape the moldable surface over the target object, shape the moldable surface into the target form factor while vacuuming the encapsulating bladder. Then the maximum vacuum pressure attainable may be applied to encapsulating bladder to rigidly hold the target form. Yet another approach is to drape the moldable surface over the target object, shape the moldable surface into the target form factor while vacuuming the encapsulating bladder, and inflate all tiles simultaneously. Additionally, graded functionalities may be used, such as varying stiffness or creating soft and rigid regions on one surface (e.g., by implementing selective operation of individual tiles using various valving and plumbing strategies). Moreover, stowing the moldable surface may be achieved by vacuuming air out of the tile array(s) while inflating the bladder (e.g., with the result being an easily deformable surface that can be rolled up).

The method 170 therefore enhances performance at least to the extent that selectively inflating the tile array(s) and vacuuming the bladder provides compactness in both solid and rigid states. The inflatable tile array(s) also reduce the overall weight of the moldable surface and render the moldable surface more scalable (e.g., to larger sizes).

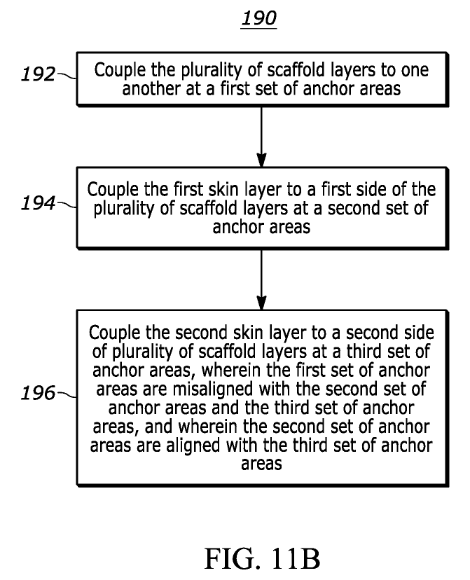

FIG. 11A shows a method 180 of fabricating a moldable surface such as, for example, the moldable surface 20 (FIG. 1), the moldable surface 40 (FIG. 3), the moldable surface 80 (FIG. 5), the moldable surface 90 (FIG. 6), the moldable surface 120 (FIG. 7) and/or the moldable surface 160 (FIG. 9), already discussed. The method 170 may be implemented via manufacturing equipment and/or in logic instructions (e.g., software), configurable logic, fixed-functionality hardware logic, etc., or any combination thereof. Illustrated processing block 182 provides for constructing a bladder. In an embodiment, block 182 includes sealing bladder layers together at two or more edges to create a compartment. Block 184 positions a first tile array within the bladder and block 186 positions a second tile array within the bladder, wherein tiles in the second tile array are offset from tiles in the first tile array. In an embodiment, the first tile array and the second tile array are deformable and inflatable. The method 180 may also provide for coupling a tile array nozzle to the first and second tile arrays, coupling a bladder nozzle to the bladder, and sealing the bladder to achieve an airtight compartment containing the first and second tile arrays. The method 180 therefore further enhances performance at least to the extent that the inflatable tile arrays are lightweight and provide compactness in both solid and rigid states. Additionally, the offset arrangement increases the shaping granularity of the moldable surface.

FIG. 11B shows a method 180 of fabricating a moldable surface when one or more tiles in at least one of the tile arrays includes a plurality of scaffold layers, a first skin layer and a second skin layer. The method 180 can be used to fabricate a moldable surface such as, for example, the moldable surface 20 (FIG. 1), the moldable surface 40 (FIG. 3), the moldable surface 80 (FIG. 5), the moldable surface 90 (FIG. 6), the moldable surface 120 (FIG. 7) and/or the moldable surface 160 (FIG. 9), already discussed. The method 180 may be implemented in conjunction with the method 170 (FIG. 11B) via manufacturing equipment and/or in logic instructions (e.g., software), configurable logic, fixed-functionality hardware logic, etc., or any combination thereof.

Illustrated processing block 192 provides for coupling the plurality of scaffold layers to one another at a first set of anchor areas. In one example, block 192 includes applying pressure and/or heat to the scaffold layers at the first set of anchor areas. Block 194 couples the first skin layer to a first side of the plurality of scaffold layers at a second set of anchor areas. In an embodiment, block 194 includes applying pressure and/or heat to the first skin layer and the first side of the scaffold layers at the second set of anchor areas. Block 196 couples the second skin layer to a second side of the plurality of scaffold layers at a third set of anchor areas, wherein the first set of anchor areas are misaligned with the second set of anchor areas and the third set of anchor areas. In the illustrated example, the second set of anchor areas are aligned with the third set of anchor areas. In an embodiment, block 196 includes applying pressure and/or heat to the second skin layer and the second side of the scaffold layers at the third set of anchor areas. The first set of anchor areas, the second set of anchor areas and the third set of anchor areas may be defined with one or more of masks or water-based ink. The method 190 therefore further enhances performance at least to the extent that resulting structure is lightweight and compact.

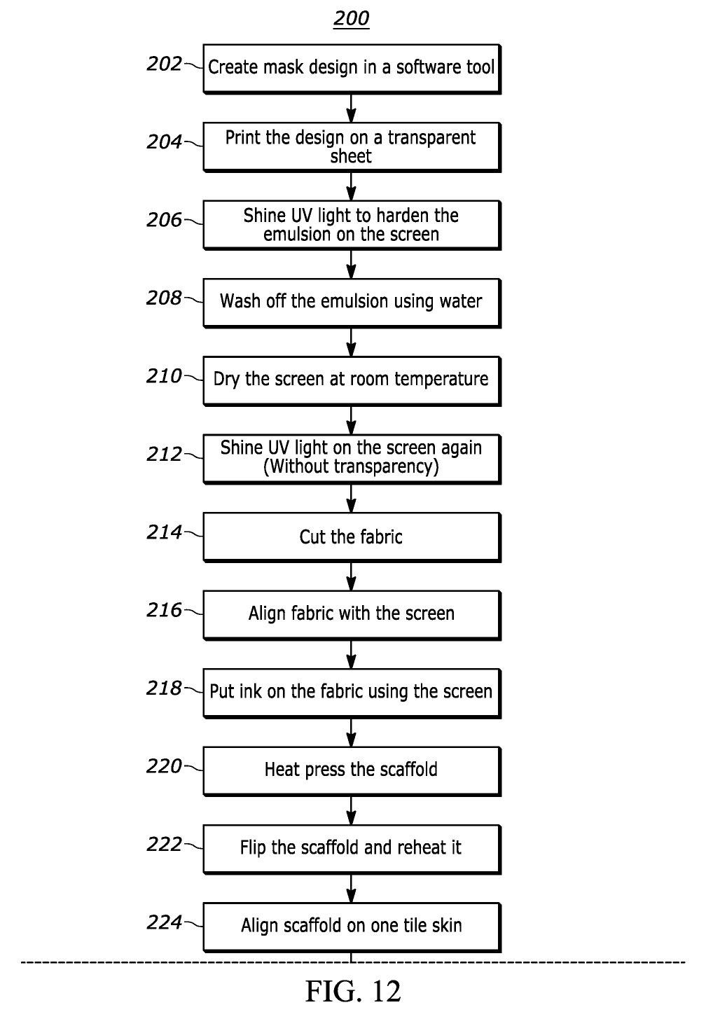

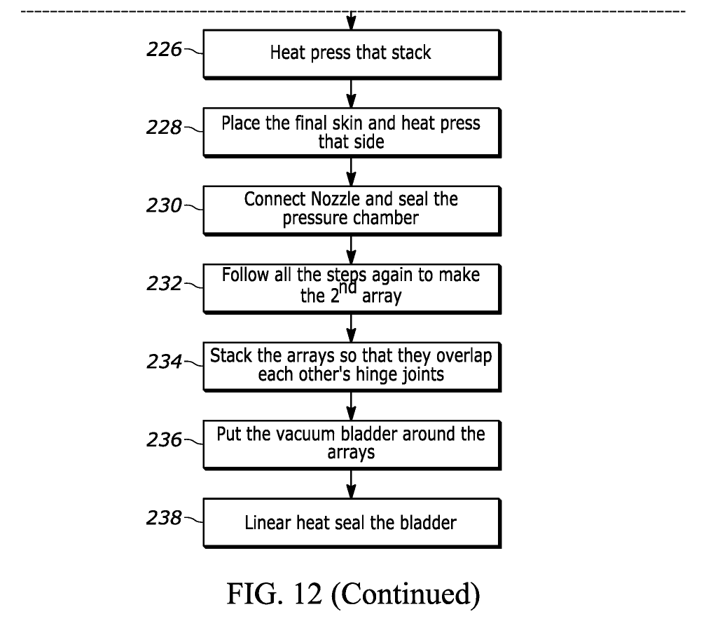

FIG. 12 shows a more detailed method 200 of fabricating a moldable surface using screen-printing technology. The method 200 can be used to fabricate a moldable surface such as, for example, the moldable surface 20 (FIG. 1), the moldable surface 40 (FIG. 3), the moldable surface 80 (FIG. 5), the moldable surface 120 (FIG. 7) and/or the moldable surface 160 (FIG. 9), already discussed. The method 180 may be implemented via manufacturing equipment and/or in logic instructions (e.g., software), configurable logic, fixed-functionality hardware logic, etc., or any combination thereof.

Illustrated processing block 202 creates a mask design in a software tool such as, for example, ADOBE ILLUSTRATOR. Block 204 prints the design on a transparent sheet and block 206 shines ultraviolet (UV) light on a screen to harden an emulsion on the screen. Block 208 washes off the emulsion using water and block 210 dries the screen at room temperature. Block 212 may shine UV light on the screen again, without transparency, wherein block 214 cuts the fabric. In an embodiment, block 216 aligns the fabric with the screen, and block 218 places ink on the fabric using the screen. Block 220 heat presses the scaffold layers and block 222 flips the scaffold layers and reheats the scaffold layers. In one example, block 224 aligns the scaffold layers on one tile skin, wherein block 226 heat presses that stack. Additionally, block 228 places the final skin on the other side of the stack and heat presses that side. Block 230 connects a nozzle and seals the tile array (e.g., pressure chamber). Block 232 repeats the preceding operations to create a second tile array and block 234 stacks the tile arrays in such a way that the arrays overlap their respective hinge joints. In addition, block 236 places the bladder around the arrays, wherein block 238 conducts a linear heat seal around the edges of the bladder.

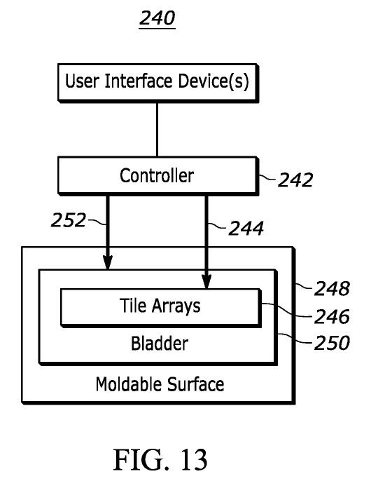

FIG. 13 shows a control system 240 that may implement one or more aspects of the method 170 (FIG. 10), already discussed. In the illustrated example, a controller 242 (e.g., microprocessor) issues a first signal 244 to inflate one or more tile arrays 246 of a moldable surface 248, wherein the moldable surface 248 is associated with one or more objects (not shown). In an embodiment, the tile array(s) 246 are positioned within a bladder 250. In such a case, the controller 242 issues a second signal 252 to vacuum air out of the bladder 250, wherein vacuuming the air out of the bladder 250 may cause the moldable surface 248 to hold the form factor of the object(s).

The technology described herein therefore provides an entirely fabric-based moldable surface system that can transition between soft and rigid states, is highly lightweight and is compactly stowable. The moldable surface is capable of passively conforming to varying shapes, activating to rigidly hold the shape or object, and then resetting back to a fabric-like “drapable” condition applicable in a variety of industries. The architecture of the surface system may be limited to fabric layers, making the fabrication process easier. Additionally, the technology described herein may use non-textile based thin layers as an alternative. Any type of flexible (e.g., bendable) and inextensible (e.g., cannot elongate when pulled apart) airtight sheet material may also be used (e.g., biaxially-oriented polyethylene terephthalate, also known as MYLAR).

Additionally, the fabrication of the moldable surface with embedded inflatable tile arrays involves creating permanently attached regions in the structure. Two alternative fabrication techniques accomplishing the permanent attachment: using physical masking layers (e.g., parchment paper layers cut to specific shapes) to define the regions to be permanently attached between fabric layers; and using screen printing solutions to apply a thin substrate (e.g., made of water-based ink) on the fabric layers to create embedded masking layers. Screen printing reduces the overall system thickness since no parchment paper layers remain inside the system upon the completion of the fabrication. Moreover, the moldable surface can be mass manufactured using roll-to-roll fabrication technique as well as other techniques.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A moldable surface comprising:
a bladder;
a first tile array positioned within the bladder; and
a second tile array positioned within the bladder, wherein the first tile array and the second tile array are deformable and inflatable.

2. The moldable surface of claim 1, wherein one or more tiles in at least one of the tile arrays includes:
a plurality of scaffold layers, wherein the plurality of scaffold layers are coupled to one another at a first set of anchor areas,
a first skin layer coupled to a first side of the plurality of scaffold layers at a second set of anchor areas, and
a second skin layer coupled to a second side of the plurality of scaffold layers at a third set of anchor areas, wherein the first set of anchor areas are misaligned with the second set of anchor areas and the third set of anchor areas, and wherein the second set of anchor areas are aligned with the third set of anchor areas.

3. The moldable surface of claim 2, wherein the one or more tiles further include:
an inner mask positioned between the plurality of scaffold array layers, wherein the inner mask defines the first set of anchor areas;
a first outer mask positioned between the first skin layer and the first side of the plurality of scaffold layers, wherein the first outer mask defines the second set of anchor areas; and
a second outer mask positioned between the second skin layer and the second side of the plurality of scaffold layers, wherein the second outer mask defines the third set of anchor areas.

4. The moldable surface of claim 2, wherein the one or more tiles further include inner water-based ink positioned between the plurality of scaffold layers, and wherein the inner water-based ink defines inflatable regions around the first set of anchor areas.

5. The moldable surface of claim 2, wherein the one or more tiles further include:
first outer water-based ink positioned between the first skin layer and the first side of the plurality of scaffold layers, wherein the first outer water-based ink defines inflatable regions around the second set of anchor areas, and
second outer water-based ink positioned between the second skin layer and the second side of the plurality of scaffold layers, wherein the second outer water-based ink defines inflatable regions around the third set of anchor areas.

6. The moldable surface of claim 2, wherein the plurality of scaffold layers include fabric coated with thermoplastic polyurethane (TPU) on two sides, and wherein the bladder, the first skin layer and the second skin layer include fabric coated with TPU on one side.

7. The moldable surface of claim 1, wherein tiles in the second tile array are offset from tiles in the first tile array.

8. An inflatable tile comprising:
a plurality of scaffold layers, wherein the plurality of scaffold layers are coupled to one another at a first set of anchor areas;
a first skin layer coupled to a first side of the plurality of scaffold layers at a second set of anchor areas; and
a second skin layer coupled to a second side of the plurality of scaffold layers at a third set of anchor areas, wherein the first set of anchor areas are misaligned with the second set of anchor areas and the third set of anchor areas, and wherein the second set of anchor areas are aligned with the third set of anchor areas.

9. The inflatable tile of claim 8, wherein the inflatable tile is deformable.

10. The inflatable tile of claim 8, further including an inner mask positioned between the plurality of scaffold layers, wherein the inner mask defines the first set of anchor areas.

11. The inflatable tile of claim 8, further including:
a first outer mask positioned between the first skin layer and the first side of the plurality of scaffold layers, wherein the first outer mask defines the second set of anchor areas; and
a second outer mask positioned between the second skin layer and the second side of the plurality of scaffold layers, wherein the second outer mask defines the third set of anchor areas.

12. The inflatable tile of claim 8, further including inner water-based ink positioned between the plurality of scaffold layers, wherein the inner water-based ink defines inflatable regions around the first set of anchor areas.

13. The inflatable tile of claim 8, further including:
first outer water-based ink positioned between the first skin layer and the first side of the plurality of scaffold layers, wherein the first outer water-based ink defines inflatable regions around the second set of anchor areas; and
second outer water-based ink positioned between the second skin layer and the second side of the plurality of scaffold layers.

14. The inflatable tile of claim 8, wherein the plurality of scaffold layers include fabric coated with thermoplastic polyurethane (TPU) on two sides, and wherein the first skin layer and the second skin layer include fabric coated with TPU on one side.

15. A method of operating a moldable surface, the method comprising:
inflating one or more tile arrays of the moldable surface, wherein the moldable surface is associated with one or more objects, and wherein the one or more tile arrays are positioned within a bladder; and
vacuuming air out of the bladder, wherein vacuuming the air out of the bladder causes the moldable surface to hold a form factor of the one or more objects.

16. The method of claim 15, wherein the air is vacuumed out of the bladder one or more of while the moldable surface is being shaped to the form factor or after the moldable surface has been shaped to the form factor.

17. The method of claim 15, wherein the moldable surface is one or more of draped over the one or more objects or placed within the one or more objects.

18. A method of fabricating a moldable surface, the method comprising:
constructing a bladder;
positioning a first tile array within the bladder; and
positioning a second tile array within the bladder, wherein tiles in the second tile array are offset from tiles in the first tile array, and wherein the first tile array and the second tile array are deformable and inflatable.

19. The method of claim 18, wherein one or more tiles in at least one of the tile arrays includes a plurality of scaffold layers, a first skin layer and a second skin layer, the method further including:
coupling the plurality of scaffold layers to one another at a first set of anchor areas;
coupling the first skin layer to a first side of the plurality of scaffold layers at a second set of anchor areas; and
coupling the second skin layer to a second side of the plurality of scaffold layers at a third set of anchor areas, wherein the first set of anchor areas are misaligned with the second set of anchor areas and the third set of anchor areas, and wherein the second set of anchor areas are aligned with the third set of anchor areas.

20. The method of claim 19, further including defining the first set of anchor areas, the second set of anchor areas and the third set of anchor areas with one or more of masks or water-based ink.
